(19) United States
(12) Patent Application Publication
(10) Pub. No.: US 2021/0187451 A1
(43) Pub. Date: Jun. 24, 2021

(54) ROTATING PROPELLER

(71) Applicant: SHANGHAI CENTURY SCIENCE & TECHNOLOGY CO., LTD, Shanghai (CN)

(72) Inventor: Xiaowei Cai, Shanghai (CN)

(73) Assignee: SHANGHAI CENTURY SCIENCE & TECHNOLOGY CO., LTD, Shanghai (CN)

(21) Appl. No.: 17/268,568

(22) PCT Filed: Feb. 20, 2020
(86) PCT No.: PCT/CN2019/095510

§ 371 Date: Feb. 15, 2021

(30) Foreign Application Priority Data
Aug. 17, 2018 (CN) 201810939207.3
Aug. 17, 2018 (CN) 201821334711.2

(51) Int. Cl. B01F 7/00

(52) U.S. Cl. CPC B01F 7/001; B01F 7/00016; B01F 7/00125; B01F 7/00341

(57) ABSTRACT

Disclosed is a rotating propeller (1), comprising a rotating shaft (2), a hub (3), and a plurality of blades (4). The rotating shaft (2) is connected to the hub (3). The plurality of the blades (4) are circumferentially and uniformly arranged by taking the axis line (201) of the rotating shaft (2) as a center. All of the blades (4) are rotatably connected to the hub (3) and can rotate along axes of rotary shafts (401) corresponding to the blades (4). All of the axes of the rotary shafts (401) do not pass through the axis line (201) of the rotating shaft (2).

### CLAIM OF PRIORITY

This application claims, under 35 U.S.C. § 371, the benefit of and priority to International Application No. PCT/CN2019/095510, filed Feb. 20, 2020, entitled ROTATING PROPELLER, which claims the benefit of and priority to Chinese Patent Application No. 2018109392073, filed Aug. 17, 2018, and Chinese Patent Application No. 2018213347112, filed Aug. 17, 2018, the entire content of the aforementioned applications is incorporated herein by reference.

### TECHNICAL FIELD

The disclosure relates to a rotating propeller.

### BACKGROUND

At present, in a blade angle-adjustable rotating propeller, the axes of rotary shafts whose blade angles are adjusted are arranged to point to the axis line of a rotating shaft of the propeller, that is, the axes of the rotary shafts whose blade angles are adjusted intersect with the axis line of the rotating shaft of the propeller. This arrangement can facilitate the adjustment of blade angles and the locking and fixing of blades, and reduce the structural complexity of a blade adjustment mechanism.

However, the axes of the rotary shafts of the blades of the rotating propeller point to the axis line of the rotating shaft of the propeller, so the force arms, at a hub end, of the blades must be very small, resulting in that the rotating torques subjected to the blades generate great acting force because of the short force arms during the rotation of the rotating propeller, so that the volume and mass of the hub of the rotating propeller must be made great enough to balance the acting force generated on the hub and the rotating shaft by the blades.

### SUMMARY

The technical problem to be solved by the disclosure is to provide a rotating propeller to overcome the defect the overall weight of the rotating propeller is heavy because a hub with great volume and mass must be used to make a blade angle-adjustable rotating propeller itself be able to rotate stably in the prior art.

The disclosure solves the aforementioned technical problems through the following technical solution:

The rotating propeller includes a rotating shaft, a hub, and a plurality of blades. The rotating shaft is connected to the hub. A plurality of the blades are circumferentially and uniformly arranged by taking the axis line of the rotating shaft as an axis line. All of the blades are rotatably connected to the hub and can rotate along the axes of the rotary shafts corresponding to the blades. The axes of all of the rotary shafts do not pass through the axis line of the rotating shaft.

According to the rotating propeller, the force arms, at a hub end, of the blades are increased by means of making the axes of the rotary shafts of the blades not pass through the axis line of the rotating shaft, and then the acting force generated on the hub by the blades under the same rotating torque is reduced, so that the acting force can be balanced without making the volume and the mass of the hub very great, thereby effectively reducing the overall weight of the rotating propeller.

Preferably, grooves which are adapted to the shapes of the rotary shafts of the blades are formed in the surface of the rotating shaft; the grooves are formed in one-to-one correspondence with the rotary shafts of the blades; the rotary shafts of the blades are all attached to the corresponding grooves.

The structure can make the blades connected to the hub adapt to the grooves in the surface of the rotating shaft through the rotary shafts of the blades, and the position of the rotating shaft relative to the hub is also fixed, so that the location between the rotating shaft and the hub is realized without forming additional location connecting structures, such as pin-key holes or journals, on the rotating shaft, thereby effectively simplifying the structure of the rotating propeller.

Preferably, a plurality of accommodating spaces are formed in the hub; the accommodating spaces are formed in one-to-one correspondence with the blades; the rotary shafts of the blades are respectively arranged in the corresponding accommodating spaces;

sealing pieces are also arranged on the rotating propeller; the sealing pieces fill the gaps between the blades and the hub to isolate the rotary shafts and the accommodating spaces from the outside.

The structure can be used for improving the corrosion resistant effect of the rotating propeller, because the corrosion resistance can be improved by means of performing, such as, surface plating, rubber lining, and spraying anti-corrosive metal or non-metallic materials, on the outer surface of the rotating propeller. However, the inner surface of the rotating propeller is of a concave structure, so it is difficult to process a corrosion-resistant layer. Even if it is forcibly processed, the corrosion resistance of the corrosion-resistant layer cannot be guaranteed. Therefore, the inner rotary shafts and the accommodating spaces are isolated from the outside by arranging the sealing pieces, so that anti-corrosion layers do not need to be arranged on the rotary shafts and the accommodating spaces, thereby improving the corrosion resistance of the rotating propeller and reducing the difficulty in arranging the anti-corrosion layers.

Preferably, the rotating propeller further includes an adjustment mechanism; the adjustment mechanism includes:

a worm, which is arranged coaxially with the rotating shaft;

a plurality of worm wheels, which are all engaged with the worm; the worm wheels are arranged in one-to-one correspondence with the blades and are connected to the corresponding blades, so that the worm drives all of the blades to rotate synchronously along the axes of the corresponding rotary shafts.

In the adjustment mechanism of the rotating propeller, since the worm of the adjustment mechanism and the rotating shaft are kept in coaxial arrangement, and the worm must have a certain diameter, all of the worm wheels which are engaged with the worm and the blades may rotate along the axes of the rotary shafts which do not intersect with the axis line of the rotating shaft. Compared with the propeller in the prior art, the rotating propeller increases the force arms, at the hub end, of the blades, and then reduces the acting force generated on the hub and the rotating shaft by the blades under the same rotating torque, so that the acting force can be balanced without making the volume and mass of the hub very great; therefore, the overall weight of the rotating propeller can be reduced effectively.

In addition, the adjustment mechanism of the rotating propeller can realize synchronous adjustment of the blade angles by adopting a single worm and worm wheels with the same number as the blades, which effectively reduces the structural complexity of the rotating propeller.

Preferably, the adjustment mechanism further includes an adjustment shaft; the adjustment shaft is shafted to the worm; the worm can be driven to rotate by rotating the adjustment shaft.

Preferably, the adjustment shaft is arranged in the rotating shaft in a sleeving manner to lead out an interface for controlling the rotation of the worm from the rotating shaft.

During normal use of the rotating propeller, if the adjustment shaft and the rotating shaft rotate synchronously, then the blades rotate along with the rotating propeller as a whole, and the blade angles do not change; when the blade angles need to be adjusted, the angles of the blades may be changed by changing the speed difference between the adjustment shaft and the rotating shaft, namely, making the adjustment shaft and the rotating shaft operate at a differential speed.

Preferably, the worm is located in the hub, so the hub can cover and protect the worm, thereby avoiding the damage to the worm by the external use environment to affect the service durability of the adjustment mechanism.

Preferably, a plurality of accommodating spaces are formed in the hub; the accommodating spaces are formed in one-to-one correspondence with the blades; the worm wheels of the blades are respectively arranged in the corresponding accommodating spaces; all of the accommodating spaces are communicated with the worm, so that the worm wheels are engaged with the worm.

A plurality of accommodating spaces used for accommodating the worm wheels are formed in the hub, so the worm wheels may also be located inside the hub and are engaged with the worm inside the hub, thereby further improving the service durability of the adjustment mechanism and avoiding the influence on the normal use of the adjustment mechanism caused by the external use environment.

Preferably, connecting shafts are arranged on all of the blades; a plurality of through holes which are formed in one-to-one correspondence with the connecting shafts are formed in the hub; the connecting shafts penetrate through the through holes and are rotatably connected to the hub.

The aforementioned technical solution provides a better implementation structure for rotatably connecting the blades to the hub.

Preferably, the connecting shafts are screws; one end, penetrating through each through hole, of the corresponding connecting shaft is in threaded connection with a nut to limit the relative position between the blades and the hub through the nuts.

Preferably, the rotating propeller is a mixing propeller.

When the rotating propeller is used as the mixing propeller of a mixer, the overall weight of the rotating propeller can be effectively reduced by reducing the mass of the hub, so that the critical rotating speed of a rotary mixing mechanism of the mixer is increased, thereby improving the reliability of the mixer.

The disclosure has the positive progress effects that:

the rotating propeller increases the force arm, at the hub end, of the blades by making the axes of the rotary shafts of the blades not pass through the axis line of the rotating shaft, and then reduces the acting force generated on the hub and the rotating shaft by the blades under the same rotating torque, so that the acting force can be balanced without making the volume and mass of the hub very great, thereby effectively reducing the overall weight of the rotating propeller.

### BRIEF DESCRIPTION OF THE DRAWINGS

FIG. 1 is a schematic vertical view of a rotating propeller according to Embodiment 1 of the disclosure.

FIG. 2 is a schematic vertical view of a rotating propeller according to Embodiment 2 of the disclosure.

FIG. 3 is a schematic structural view of a rotating shaft of the rotating propeller according to the Embodiment 2 of the disclosure.

FIG. 4 is a schematic structural diagram of partial interior of a rotating propeller according to Embodiment 3 of the disclosure.

FIG. 5 is a schematic vertical view of a rotating propeller according to Embodiment 4 of the disclosure.

FIG. 6 is a schematic front view of the rotating propeller according to the Embodiment 4 of the disclosure.

FIG. 7 is a schematic structural diagram of an exploded state of the rotating propeller according to the Embodiment 4 of the disclosure.

FIG. 8 is a schematic structural diagram of an adjustment mechanism of the rotating propeller according to the Embodiment 4 of the disclosure.

### REFERENCE SIGNS IN THE DRAWINGS

Rotating propeller 1
Rotating shaft 2, axis line 201, groove 202
Hub 3, accommodating space 31, through hole 32
Blade 4, connecting shaft 41, rotary shaft 401
Adjustment mechanism 5
Worm 51, engagement surface 511
Worm wheel 52
Adjustment shaft 53
Nut 6
Sealing piece 7

### DETAILED DESCRIPTION

The disclosure will be further described below by giving several embodiments, however, the disclosure is not limited to the scope of the embodiments.

### Embodiment 1

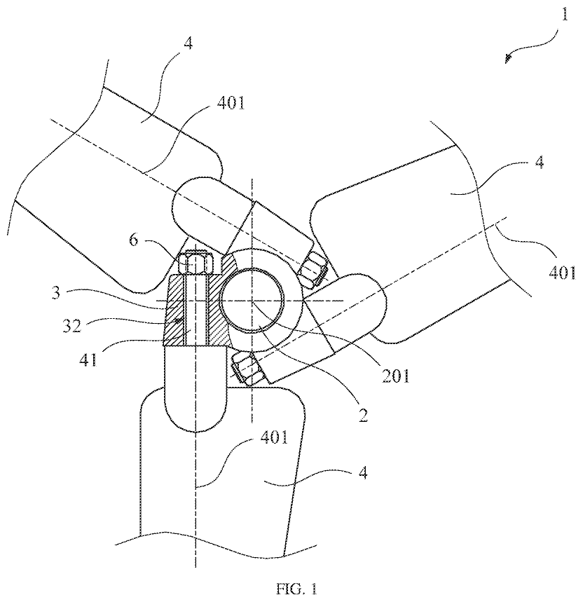

As shown in FIG. 1, the present embodiment provides a rotating propeller 1, which includes a rotating shaft 2, a hub 3, and a plurality of blades 4. The rotating shaft 2 is connected to the hub 3. The plurality of the blades 4 are uniformly and circumferentially arranged by taking the axis line 201 of the rotating shaft as a center. These blades 4 are connected to the hub 3 and rotate relative to the hub 3 along the axes of the rotary shafts 401 corresponding to all of blades 4, wherein the axes of all of the rotary shafts 401 do not pass through the axis line 201 of the rotating shaft 2.

Compared with the existing propeller, the rotating propeller 1 provided by the disclosure increases the force arms, at a hub end, of the blades 4 by making the axes of the rotary shafts 401 of the blades 4 not pass through the axis line 201 of the rotating shaft 2, and then reduces the acting force generated on the hub and the rotating shaft 2 by the blades 4 under the same rotating torque, so that the acting force can be balanced without making the volume and mass of the hub 3 very great, thereby effectively reducing the overall weight of the rotating propeller 1.

The technical solution breaks away the solution of correspondingly increasing the volume and mass of the hub in order to improve the stability of the blade angle-adjustable rotating propeller. The acting force generated by the blades on the hub and the rotating shaft is reduced fundamentally by changing the layout positions of the blades, so that the volume and mass of the hub do not need to be increased correspondingly.

As shown in FIG. 1, in the present embodiment, a connecting shaft 41 is arranged on each blade 4, and a plurality of through holes 32 which are formed in one-to-one correspondence with the connecting shafts 41 are formed in the hub 3. The blades 4 are rotatably connected to the hub 3 by means of penetrating the connecting shafts 41 of the blades 4 into the through holes 32. The aforementioned technical solution provides a better implementation structure for rotatably connecting the blades 4 to the hub 3, wherein the connecting shafts 41 may be screws, and the connecting shafts 41 make the positional relationship between the overall worm wheel 52 and the through holes 32 fix by connecting with the nuts 6 after penetrating through the through holes 32 of the hub 3. When the blade angles of the blades 4 need to be adjusted, the nuts are loosened, and the blades 4 are manually rotated to desired angles and are locked again. The technical solution meets the demand of adjusting the blade angle of each blade 4 by means of a simple structure, thereby effectively reducing the structural complexity of the rotating propeller 1.

In the present embodiment, the rotating propeller includes three blades, but this is only used for illustrating the specific structure and solution of the disclosure. It can be seen from the specific technical solution that the change of the actual number of the blades does not affect the rotating propeller provided by the disclosure to achieve beneficial effects. Therefore, all changes to the number of blades will fall within the protection scope of the disclosure.

In addition, compared with using the rotating propeller as a propeller of other equipment, such as a wind turbine, a rotorcraft, a fan or a blower, the rotating propeller can also achieve additional beneficial effects when it is used as a mixing propeller in a mixer. Specifically, as the mixing propeller, in order to be able to extend into the interior of a material to be mixed, the length of its rotating shaft must be much greater than other propellers, which also leads to the limitation of the critical speed of the mixing propeller, that is, the rotating speed of the mixing propeller must be less than a certain value, if the rotating speed of the mixing propeller exceeds the certain value, the rotating shaft and the blades of the mixing propeller will produce uncontrollable shaking, resulting in the damage to the mixing propeller or even the whole mixer.

Since the critical rotating speed value of the mixing propeller is negatively related to the weight of the mixing propeller itself, the rotating propeller provided by the disclosure can effectively reduce the overall weight of the rotating propeller by reducing the mass of the hub without reducing the mixing effect, so that the critical speed of the rotating propeller is increased, thereby improving the reliability of the mixer.

### Embodiment 2

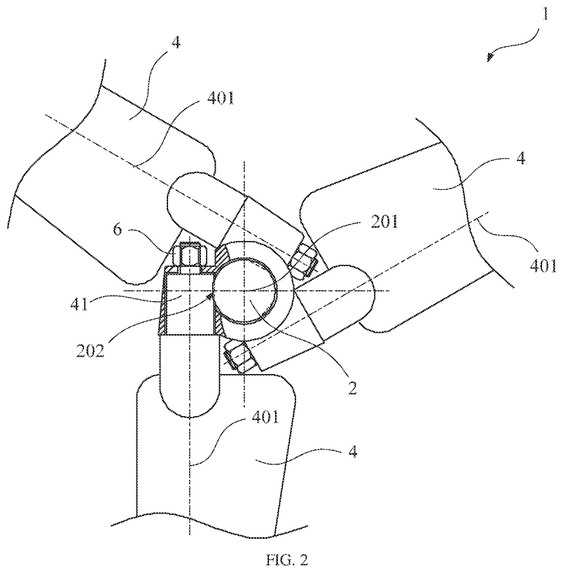

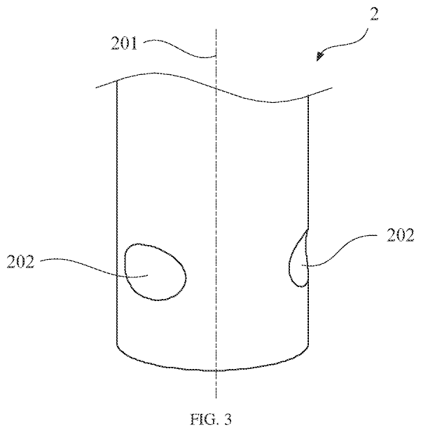

As shown in FIG. 2 and FIG. 3, the present embodiment provides a rotating propeller 1, which has substantially the same structure as the rotating propeller 1 provided in Embodiment 1. The difference is that, in the present embodiment, grooves 202 which are matched with the shapes of the rotary shafts 401 of the blades are formed in the outer surface of the rotating shaft 2 of the rotating propeller 1. These grooves 202 are formed in one-to-one correspondence with the rotary shafts 401 of the blades 4, and the rotary shafts 401 of the plurality of blades 4 are all attached to the interior of the corresponding grooves 202, so these blades 4 connected to the hub 3 can be matched with the grooves 202 in the surface of the rotating shaft 2 through the rotary shafts 401 of the blades 4, and the position of the rotating shaft 2 relative to the hub 3 is also fixed, so that the location between the rotating shaft 2 and the hub 3 is realized without forming additional location connecting structures, such as pin-key holes or journals, on the rotating shaft 2, thereby effectively simplifying the structure of the rotating propeller 1.

In addition, in the case that the rotating shaft 2 is made of a hollow tube, the pin-key holes or journals cannot be formed in the surface of the tube due to the limitation of the wall thickness of the tube, and the grooves 202 in the present embodiment are not limited by the wall thickness because the grooves 202 are intermittently formed in the surface of the rotating shaft, thereby effectively solving the problem about how to effectively fix the rotating shaft 2 made of the hollow tube to the hub 3. Of course, when the rotating shaft 2 is made of the tube with great wall thickness, the depths of the grooves 202 in the surface of the rotating shaft 2 may be less than the wall thickness, so the outer surface of the rotating shaft 2 cannot be communicated with an inner hollow part through the grooves 202.

In the present embodiment, since the shapes of the rotary shafts 401 of the blades 4 are cylindrical, the grooves 202 of the rotating shaft 2 are correspondingly arc-shaped, but the shapes of the grooves 202 are not only limited to the arc shape. Other shapes matching the shapes of the corresponding rotary shafts 401 will also fall within the protection scope of the disclosure.

### Embodiment 3

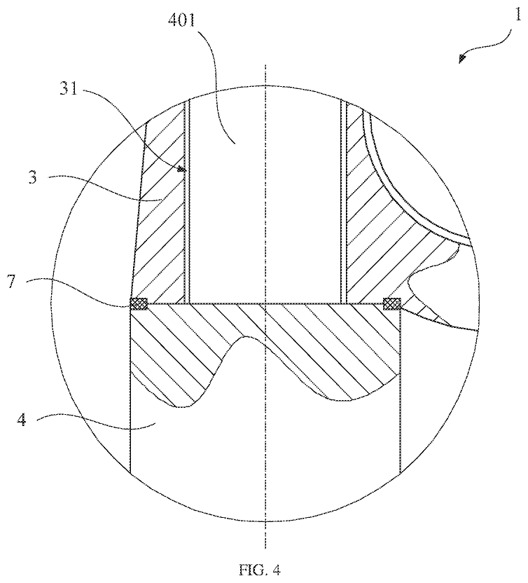

As shown in FIG. 4, the present embodiment provides a rotating propeller 1, which has substantially the same structure as the rotating propeller 1 provided in the Embodiment 2. The difference is that, in the present embodiment, a plurality of the accommodating spaces 31 are formed in the hub 3 of the rotating propeller 1; these accommodating spaces 31 are formed in one-to-one correspondence with the blades 4; the rotary shafts 401 of the blades 4 are respectively arranged in the corresponding accommodating spaces 31.

Sealing pieces 7 are also arranged on the rotating propeller 1. In the present embodiment, taking the sealing pieces 7 being circular sealing rings as an example: the sealing pieces 7 fill the gaps between the blades 4 and the hub 3, so that the rotary shafts 401 of the blades 4 and the accommodating spaces 31 of the hub 3 are isolated from the outside by the sealing pieces 7 when the blades 4 are connected to the hub 3, that is, the internal structure of the rotating propeller 1 is isolated from the outside by the seal 7.

The structure can be used for improving the corrosion resistant effect of the rotating propeller 1, because the corrosion resistance can be improved by means of performing, such as, surface plating, rubber lining, and spraying anti-corrosive metal or non-metallic materials, on the outer surface of the rotating propeller 1. However, the inner surface of the rotating propeller 1 is of a concave structure, so it is difficult to process a corrosion-resistant layer. Even if it is forcibly processed, the corrosion resistance of the corrosion-resistant layer cannot be guaranteed. Therefore, the inner rotary shafts 401 and the accommodating spaces 31 are isolated from the outside by arranging the sealing pieces 7, so that anti-corrosion layers do not need to be arranged on the surfaces of the rotary shafts 401 and the inner surfaces of the accommodating spaces 31, but only need to be arranged on relatively smooth surfaces opposite to the rotating propeller 1, thereby improving the corrosion resistance of the rotating propeller 1 and reducing the difficulty in arranging the anti-corrosion layers.

In addition, since the blades 4 are connected to the hub 3 in a detachable manner, it is very easy and convenient to arrange and mount the sealing pieces 7, which facilitates maintenance and adjustment.

### Embodiment 4

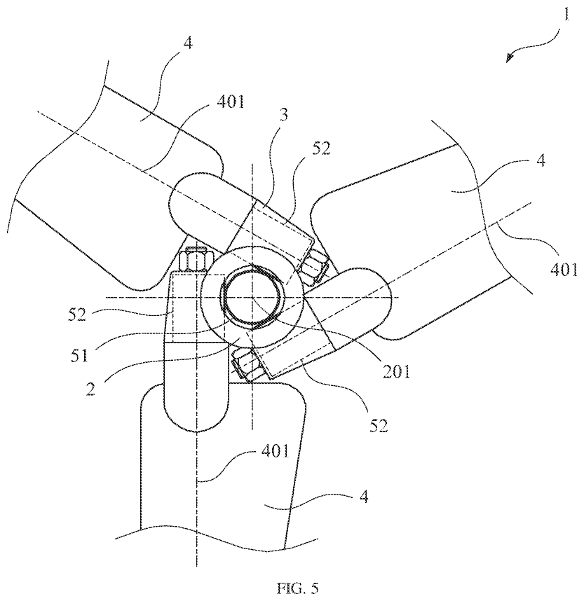

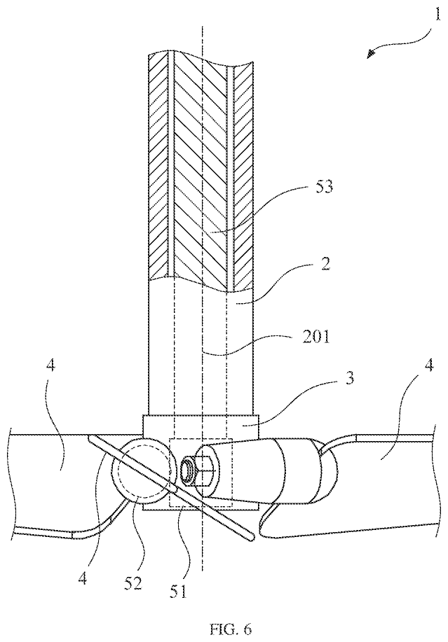

As shown in FIG. 5 and FIG. 6, the present embodiment provides a rotating propeller 1, which has substantially the same structure as the rotating propeller 1 provided in the Embodiment 2. The difference is that, in the present embodiment, the rotating propeller 1 further includes an adjustment mechanism 5. The adjustment mechanism 5 includes a worm 51 and a plurality of worm wheels 52, wherein the worm 51 and the rotating shaft 2 are arranged coaxially; the plurality of the worm wheels 52 are all engaged with the worm 51; these worm wheels 52 are arranged in one-to-one correspondence with the blades 4; the worm wheels 52 are connected to the corresponding blades 4, so that the single worm 51 drives all of the worm wheels 52 and the blades 4 connected thereto to rotate synchronously, thereby realizing synchronous adjustment the blade angles of all of the blades 4. In the adjustment mechanism 5 of the rotating propeller 1, since the worm 51 of the adjustment mechanism 5 and the rotating shaft 2 are kept in coaxial arrangement, and the worm 51 must have a certain diameter, all of the worm gears and the blades 4 which are engaged with worm 51 rotate along the axes of the rotary shafts 401 that do not intersect with the axis line 201 of the rotating shaft 2; the force arms, at a hub end, of the blades 4 are increased, and then the acting force generated on the hub and the rotating shaft 2 by the blades 4 under the same rotating torque is reduced, so that the acting force can be balanced without making the volume and the mass of the hub 3 very great, thereby effectively reducing the overall weight of the rotating propeller 1.

In addition, the adjustment mechanism 5 of the rotating propeller 1 can realize the synchronous adjustment of the blade angles by using the single worm 51 and the worm wheels 52 with same number as the blades 4, which effectively reduces the structural complexity of the rotating propeller 1.

How to drive the worm 51 in the adjustment mechanism 5 to rotate can be implemented in an automatic or manual manner, and the specific structures of these implementation manners are all existing technologies, which will not be described in detail herein.

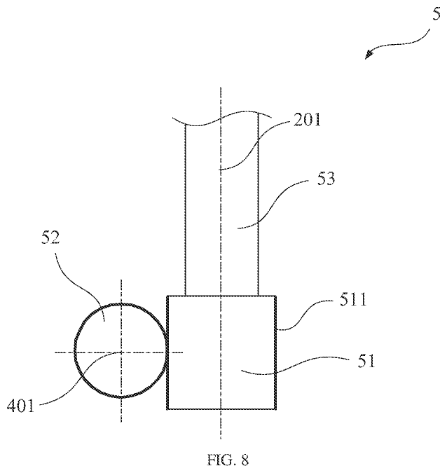

As shown in FIG. 6 and FIG. 8, the adjustment mechanism 5 further includes an adjustment shaft 53. The adjustment shaft 53 is shafted to the worm 51. The worm 51 can be driven to rotate by rotating the adjustment shaft 53. In addition, the adjusting shaft 53 can be arranged in the rotating shaft 2 in a sleeving manner so as to lead out the interface for controlling the rotation of the worm 51 from the rotating shaft 2. When the rotating propeller 1 is in normal use, if the adjusting shaft 53 and the rotating shaft 2 rotate synchronously, the blades 4 rotate with the rotating propeller 1 as a whole, and the blade angles do not change; when the blade angles need to be adjusted, the angles of the blades 4 may be changed by changing the speed difference between the adjustment shaft 53 and the rotating shaft 2, namely, making the adjustment shaft 53 and the rotating shaft 2 operate at a differential speed. In the adjustment method, the function of adjusting the blade angle during the overall rotating process of the rotating propeller 1 is achieved by simultaneously shafting the adjustment shaft 53 and the tail end of the rotating shaft 2 to a differential (not shown in the drawing). The specific structure and the use method of the differential are all existing technologies, which will not be described in detail herein.

As shown in FIG. 6, the worm 51 of the adjustment mechanism 5 may be located in the hub 3, so the hub 3 can cover and protect the worm 51, thereby avoiding damage to the worm 51 by the external use environment to affect the durability of the adjustment mechanism 5.

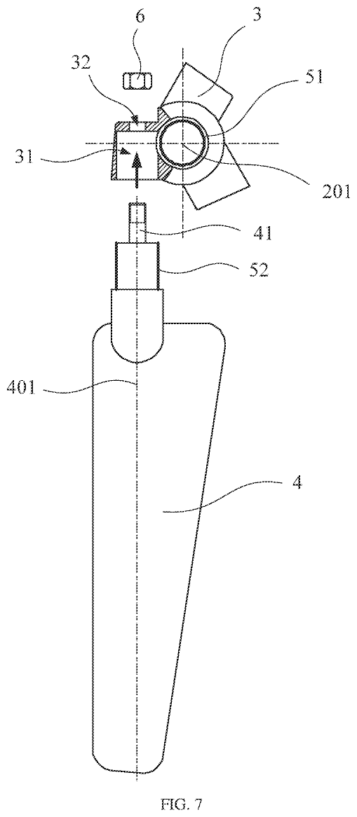

As shown in FIG. 5 and FIG. 7, a plurality of accommodating spaces 31 are further formed in the hub 3; these accommodating spaces 31 are formed in one-to-one correspondence with the blades 4; the worm wheels 52 of the blades 4 are mounted in the corresponding accommodating spaces 31 along the directions shown by the arrows in FIG. 7. All of these accommodating spaces 31 are communicated with the worm 51, so the worm wheels 52 can be engaged with the worm 51. The plurality of the accommodating spaces 31 used for accommodating the worm wheels 52 are formed in the hub 3, so the worm wheels 52 may also be located inside the hub 3 and are engaged with the worm 51 inside the hub 3, thereby further improving the service durability of the adjustment mechanism 5 and avoiding the influence on the normal use of the adjustment mechanism 5 by the external use environment.

In addition, in the present embodiment, through holes 32 are also formed in the hub 3. The blades 4 are rotatably connected to the hub 3 by means of also penetrating the connecting shafts 41 of the blades 4 into the through holes 32 similarly. As shown in FIG. 6, the connecting shafts 41 are also connected to the nuts 6 after passing through the through holes 32 to limit the relative positions between the blades 4 and the hub 3. The worm wheels 52 are arranged on the connecting shafts 41 to drive the connecting shafts 41 and the overall blades 4 to rotate synchronously under the driving of the worm 51.

In the description of the disclosure, it should be understood that the orientations or positional relationships indicated by the terms “upper”, “lower”, “front”, “rear”, “left”, “right”, “vertical”, “horizontal”, “top”, “bottom”, “inner”, “outer”, etc. are based on the orientations or positional relationships shown in the accompanying drawings, only for facilitating description of the disclosure and simplifying the description, rather than indicating or implying that the apparatuses or components must have specific orientations or must be constructed and operated in specific orientations, and thus may not be interpreted as limitation to the disclosure.

Although the specific embodiments of the disclosure have been described above, those skilled in the art should understand that this is only an example, and the protection scope of the disclosure is defined by the appended claims. Those skilled in the art can make various changes or modifications to these embodiments without departing from the principle and essence of the disclosure, but these changes and modifications all fall within the protection scope of the disclosure.

1-11. (canceled)

12. A rotating propeller comprising:
a rotating shaft;
a hub; and
blades, wherein the rotating shaft is connected to the hub, wherein the blades are circumferentially and uniformly arranged by taking an axis line of the rotating shaft as a center, wherein the blades are connected to the hub and capable of being rotated along axes of the rotary shafts corresponding to the blades, and wherein the axes of rotary shafts avoid passing through the axis line of the rotating shaft.

13. The rotating propeller according to claim 12, further comprising grooves that are adapted to shapes of the rotary shafts of the blades are formed on a surface of the rotating shaft, wherein the grooves are formed in one-to-one correspondence with the rotary shafts of the blades, and wherein the rotary shafts of the blades are attached to interiors of the corresponding grooves.

14. The rotating propeller according to claim 12, further comprising:
accommodating spaces that are formed in the hub, wherein the accommodating spaces are formed in one-to-one correspondence with the blades, and wherein the rotary shafts of the blades are respectively arranged in the corresponding accommodating spaces; and
sealing pieces arranged on the rotating propeller such that the sealing pieces fill gaps between the blades and the hub to isolate the rotary shafts and the accommodating spaces from outside.

15. The rotating propeller according to claim 12, further comprising an adjustment mechanism including:
a worm arranged coaxially with the rotating shaft;
worm wheels engaged with the worm, wherein the worm wheels are arranged in one-to-one correspondence with the blades, and wherein the worm wheels are connected to the corresponding blades such that the worm drives the blades to rotate synchronously along the axes of the corresponding rotary shafts.

16. The rotating propeller according to claim 15, wherein the adjustment mechanism further comprises an adjustment shaft that is shafted to the worm.

17. The rotating propeller according to claim 16, wherein the adjustment shaft is arranged in the rotating shaft in a sleeving manner.

18. The rotating propeller according to claim 15, wherein the worm is located in the hub.

19. The rotating propeller according to claim 18, wherein the accommodating spaces are formed in the hub in one-to-one correspondence with the blades, wherein the worm wheels of the blades are respectively arranged in the corresponding accommodating spaces in communication with the worm such that the worm wheels are engaged with the worm.

20. The rotating propeller according to claim 12, further comprising a connecting shaft arranged on each of the blades; and through holes in one-to-one correspondence with connecting shafts and formed in the hub, wherein the connecting shafts are arranged in the through holes in a penetrating manner and are rotatably connected to the hub.

21. The rotating propeller according to claim 13, further comprising a connecting shaft is arranged on each of the blades; and through holes in one-to-one correspondence with connecting shafts and formed in the hub, wherein the connecting shafts are arranged in the through holes in a penetrating manner and are rotatably connected to the hub.

22. The rotating propeller according to claim 14, further comprising a connecting shaft is arranged on each of the blades; and through holes in one-to-one correspondence with the connecting shafts and formed in the hub, wherein the connecting shafts are arranged in the through holes in a penetrating manner and are rotatably connected to the hub.

23. The rotating propeller according to claim 15, further comprising a connecting shaft is arranged on each of the blades; and through holes in one-to-one correspondence with the connecting shafts and formed in the hub, wherein the connecting shafts are arranged in the through holes in a penetrating manner and are rotatably connected to the hub.

24. The rotating propeller according to claim 16, further comprising a connecting shaft is arranged on each of the blades; and through holes in one-to-one correspondence with the connecting shafts and formed in the hub, wherein the connecting shafts are arranged in the through holes in a penetrating manner and are rotatably connected to the hub.

25. The rotating propeller according to claim 17, further comprising a connecting shaft is arranged on each of the blades; and through holes in one-to-one correspondence with the connecting shafts and formed in the hub, wherein the connecting shafts are arranged in the through holes in a penetrating manner and are rotatably connected to the hub.

26. The rotating propeller according to claim 18, further comprising a connecting shaft is arranged on each of the blades; and through holes in one-to-one correspondence with the connecting shafts and formed in the hub, wherein the connecting shafts are arranged in the through holes in a penetrating manner and are rotatably connected to the hub.

27. The rotating propeller according to claim 19, further comprising a connecting shaft is arranged on each of the blades; and through holes in one-to-one correspondence with the connecting shafts and formed in the hub, wherein the connecting shafts are arranged in the through holes in a penetrating manner and are rotatably connected to the hub.

28. The rotating propeller according to claim 20, wherein the connecting shafts comprise screws that from, one end, penetrate through each through hole of a corresponding connecting shaft that is in threaded connection with a nut.

29. The rotating propeller according to claim 12, wherein the rotating propeller comprises a mixing propeller.

30. The rotating propeller according to claim 13, wherein the rotating propeller comprises a mixing propeller.

31. The rotating propeller according to claim 14, wherein the rotating propeller comprises a mixing propeller.
